(19) United States
(12) Patent Application Publication
(10) Pub. No.: US 2006/0075325 A1
(43) Pub. Date: Apr. 6, 2006

(54) Record device with customized information function

(75) Inventor: Jakie Yeh, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 11/042,073

(22) Filed: Jan. 26, 2005

(30) Foreign Application Priority Data
Oct. 5, 2004 (TW) 093130153

(51) Int. Cl. G06F 17/00

(52) U.S. Cl. 715/500.1

(57) ABSTRACT

A record device with a customized information function, which is for a user to edit customized information, comprises a text-information receiving unit, a text-data compiling module, a figure-information receiving unit, and a figure-data processing module. The text-information receiving unit receives at least one extra-text data and at least one text-control data from an input unit. The text-data compiling module compiles the extra-text data and text-control data to generate customized text information. The figure-information receiving unit receives at least one extra-figure data and at least one figure-control data from the input unit. The figure-data processing module generates first customized image information in accordance with the extra-figure data and figure-control data.

### BACKGROUND OF THE INVENTION

1. Field of Invention

The invention relates to a record device and, in particular, to a record device with a customized information function, which allows adding customized information when the record device works.

2. Related Art

Accompanying with the progression of technology, many digital devices, such as the digital camera, digital video and the likes, have been developed. These digital devices help users to record vary kinds of information (e.g. sound and image information) so as to enrich their lives. In addition, vary kinds of storage media have been invented such as the compact disc (CD) and the digital versatile disc (DVD). The DVD has a capacity of at least 4.7 GB that is much larger than the capacity of the CD (650 MB). Regarding to the specifications, the present storage media include CD-ROM, CD-R, CD-RW, DVD-ROM, DVD-R and DVD-RW.

In prior, the information retrieved with the digital camera or digital video must be transmitted to a computer with an optical recorder, and then be burned into a CD or a DVD. After that, the CD or DVD can be played by the computer or an optical disc player to show the information.

Recently, an individual optical disc recording/playing system has been developed. Thus, the information from the digital camera, the digital video and even a television program can be recorded in a CD or a DVD by the optical disc recording/playing system only, and the computer is unnecessary. However, this method can only burn the original information to a DVD. In other words, a user cannot add any hint or extra information, such as figures or texts for illustration, so that the content of the information recorded in the DVD becomes non-plentiful and cannot be read easily.

It is therefore, an important subjective to provide a record device, which is individual for burning information and allows users to edit desired texts and figures and add the information to a CD or a DVD.

### SUMMARY OF THE INVENTION

In view of the foregoing, the invention is to provide a record device with a customized information function that allows a user to add information.

To achieve the above, a record device with a customized information function of the invention is for a user to edit customized information. The. record device includes a text-information receiving unit, a text-data compiling module, a figure-information receiving unit, and a figure-data processing module. The text-information receiving unit receives at least one extra-text data and at least one text-control data from an input unit. The text-data compiling module compiles the extra-text data and the text-control data outputted from the text-information receiving unit to generate customized text information. The figure-information receiving unit receives at least one extra-figure data and at least one figure-control data from the input unit. The figure-data processing module generates first customized image information in accordance with the extra-figure data and the figure-control data outputted from the figure-information receiving unit.

As mentioned above, the record device with a customized information function of the invention has the additional units and modules, including the text-information receiving unit, text-data compiling module, figure-information receiving unit, and figure-data processing module. Accordingly, users can edit desired information (e.g. texts and/or figures) and add the information to a CD or a DVD. As a result, the contents of the CD or DVD become more plentiful and more readable.

### BRIEF DESCRIPTION OF THE DRAWINGS

The invention will become more fully understood from the detailed description given herein below illustration only, and thus is not limitative of the present invention, and wherein:

FIG. 1 is a schematic view showing a record device with a customized information function according to a preferred embodiment of the invention; and

FIG. 2 is a schematic view showing another record device with a customized information function according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

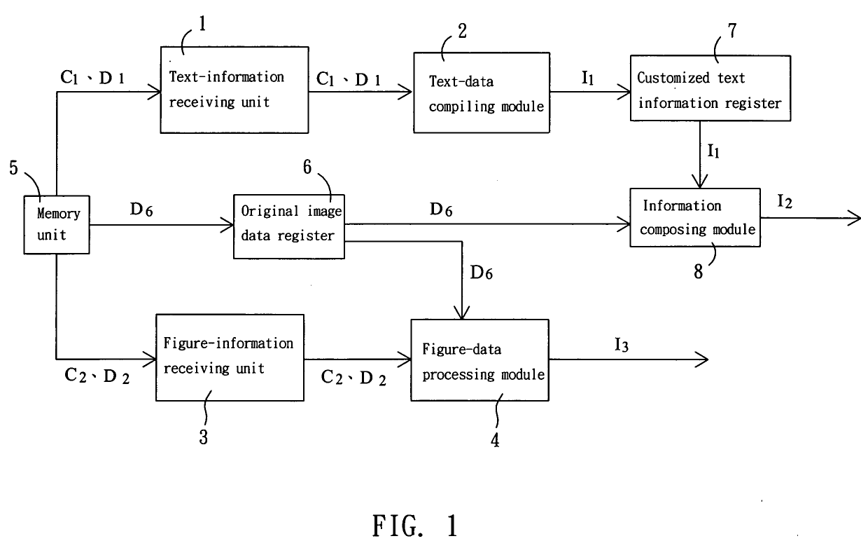

With reference to FIG. 1, a record device with a customized information function according to a preferred embodiment of the invention includes a text-information receiving unit 1, a text-data compiling module 2, a figure-information receiving unit 3, a figure-data processing module 4, a memory unit 5, an original image-data register 6, a customized text information register 7 and an information composing module 8. The memory unit 5 electrically connects to the text-information receiving unit 1 and the figure-information receiving unit 3. The original image-data register 6 electrically connects to the figure-data processing module 4 and the memory unit 5. The customized text information register 7 electrically connects to the text-data compiling module 2. The information composing module 8 electrically connects to the original image-data register 6 and the customized text information register 7.

The text-information receiving unit 1 receives at least one extra-text data D₁ and at least one text-control data C₁ from an input unit. In this embodiment, the extra-text data D₁ and text-control data C₁ are stored in the memory unit 5, and is outputted to the text-information receiving unit 1 from the memory unit 5. Alternatively, the extra-text data D₁ and text-control data C₁ can be inputted with a controller or an input interface. In this case, the memory unit 5 can be a hard disc drive, a floppy disc drive, an optical disc drive, a memory card or any other information storage medium. Herein, the information storage medium is an external information storage medium or an internal information storage medium.

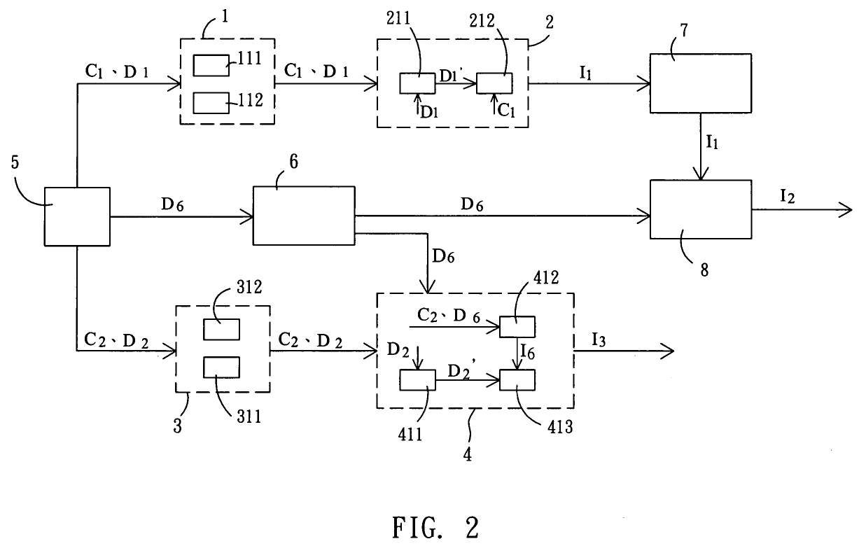

With reference to FIG. 2, the text-information receiving unit 1 further comprises an extra-text data register 111 and a text-control data register 112. The extra-text data register 111 stores the extra-text data D₁ outputted from the text-information receiving unit 1, and the text-control data register 112 stores the text-control data C₁ outputted from the text-information receiving unit 1.

The text-data compiling module 2 electrically connects to the text-information receiving unit 1 and compiles the extra-text data D₁ and the text-control data C₁ outputted from the text-information receiving unit 1 so as to generate customized text information I₁. Then, the generated customized text information I₁ is stored in the customized text information register 7, so that the information composing module 8 retrieves the generated customized text information I₁ from the customized text information register 7. In addition, the original image-data register 6 stores original image data D₆ and outputs it to the information composing module 8. Accordingly, the information composing module 8 generates a second customized image information I₂ in accordance with the customized text information I₁′ and the original image data D₆.

In the present embodiment, the text-data compiling module 2 further comprises a run length encoder 211 and a text data encoder 212, which are electrically connected with each other. The run length encoder 211 receives the extra-text data D₁ and encodes it to generate a customized text data D₁′ that is identifiable by the record device and is then transmitted to the text data encoder 212. The text data encoder 212 further receives the text-control data C₁ and then encodes the customized text data D₁′ and the text-control data C₁ to generate the customized text information I₁.

The figure-information receiving unit 3 receives at least one extra-figure data D₂ and at least one figure-control data C₂ from the input unit such as the memory unit 5.

In the embodiment, the figure-information receiving unit 3 includes an extra-figure data register 311 and a figure-control data register 312. The extra-figure data register 311 stores the received extra-figure data D₂, and the figure-control data register 312 stores the received figure-control data C₂.

The figure-data processing module 4 electrically connects to the figure-information receiving unit 3 and generates first customized image information I₃ in accordance with the extra-figure data D₂ and the figure-control data C₂.

In the current embodiment, the figure-data processing module 4 includes an extra-figure data processor 411, an information comparator 412 and a figure-information mixer 413 electrically connected with the extra-figure data processor 411 and information comparator 412. The extra-figure data processor 411 receives the extra-figure data D₂ to generate a customized figure data D₂′. The information comparator 412 receives the original image data D₆ and the figure-control data C₂ to generate original image information 16. The figure-information mixer 413 generates the first customized image information I₃ according to the original image information I₆ and the customized figure data D₂′. Herein, the extra-figure data processor 411 performs one of a scale process, a rotation process and a color matching process of the extra-figure data D₂ to generate the customized figure data D₂′.

In this case, the text-control data C₁ and the figure-control data C₂ are control data of order, time position and the likes. Thus, what timing and what position for adding the compiles the extra-text data D₁ and the extra-figure data D₂ can be defined.

Besides, the user can use a controller or other input interface to add the customized information such as the extra-text data D₁ and the extra-figure data D₂. When recording or burning the information with the record device, the customized information can be added into the original image data properly. To be noted, for receiving a customized information adding signal from the controller or input interface, the record device must further include a customized information adding signal receiving unit. In the embodiment, when playing the CD or DVD, the user can select whether to display the text data recorded in the CD or DVD.

In summary, the record device with a customized information function of the invention has the additional units and modules, including the text-information receiving unit, text-data compiling module, figure-information receiving unit, and figure-data processing module. Accordingly, users can edit desired information (e.g. texts and/or figures) and add the information to a CD or a DVD. As a result, the contents of the CD or DVD become more plentiful and more readable.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A record device with a customized information function, which is for a user to edit customized information, comprising:
a text-information receiving unit, which receives at least one extra-text data and at least one text-control data from an input unit;
a text-data compiling module, which compiles the extra-text data and the text-control data to generate customized text information;
a figure-information receiving unit, which receives at least one extra-figure data and at least one figure-control data from the input unit; and
a figure-data processing module, which generates first customized image information in accordance with the extra-figure data and the figure-control data.

2. The record device of claim 1, wherein the input unit is a memory unit, and the memory unit stores the extra-text data, the extra-figure data, the text-control data, the figure-control data and at least one original image data.

3. The record device of claim 2, wherein the memory unit is one selected from a hard disc drive, a floppy disc drive, an optical disc drive, a memory card and an information storage medium.

4. The record device of claim 1, wherein the input unit is an external information storage medium.

5. The record device of claim 1, wherein the input unit is an internal information storage medium.

6. The record device of claim 1, further comprising:
an original image-data register, which stores original image data and outputs the original image data to the figure-data processing module.

7. The record device of claim 6, further comprising:
an information composing module, which generates a second customized image information in accordance with the customized text information and the original image data.

8. The record device of claim 7, further comprising:
a customized text information register, which stores the customized text information and outputs the customized text information to the information composing module.

9. The record device of claim 1, wherein the text-information receiving unit further comprises:
an extra-text data register, which stores the extra-text data; and
a text-control data register, which stores the text-control data.

10. The record device of claim 1, wherein the text-data compiling module further comprises:
a run length encoder, which receives the extra-text data and encodes the extra-text data to generate a customized text data; and
a text data encoder, which encodes the customized text data and the text-control data to generate the customized text information.

11. The record device of claim 1, wherein the figure-information receiving unit further comprises:
an extra-figure data register, which stores the extra-figure data; and
a figure-control data register, which stores the figure-control data.

12. The record device of claim 1, wherein the figure-data processing module further comprises:
an extra-figure data processor, which receives the extra-figure data to generate a customized figure data;
an information comparator, which receives the original image data and the figure-control data to generate an original image information; and
a figure-information mixer, which generates the first customized image information according to the original image information and the customized figure data.

13. The record device of claim 12, wherein the extra-figure data processor performs one of a scale process, a rotation process and a color matching process of the extra-figure data to generate the customized figure data.

14. The record device of claim 1, further comprising:
a customized information adding signal receiving unit, which receives a customized information adding signal from one of a controller and an input interface so as to add the customized text information and/or the first customized image information to original image data.
